(19) United States
(12) Patent Application Publication
(10) Pub. No.: US 2017/0151550 A1
(43) Pub. Date: Jun. 1, 2017

(54) Method of Preparing Adsorbent for Phosphorus Adsorption and Adsorbent Prepared by the Same

(71) Applicant: Pukyong National University Industry-university Cooperation Foundation, Busan (KR)

(72) Inventor: Taeyoon LEE, Busan (KR)

(21) Appl. No.: 15/221,516

(22) Filed: Jul. 27, 2016

(30) Foreign Application Priority Data
Nov. 26, 2015 (KR) 10-2015-0166228

(51) Int. Cl. B01J 20/32; C02F 1/28; B01D 15/20; B01D 15/36; B01J 20/16; B01J 20/30

(52) U.S. Cl. CPC B01J 20/3204; B01J 20/165; B01J 20/3234; B01J 20/3078; B01J 20/3071; B01D 15/20; B01D 15/362; C02F 1/281; C02F 1/288; C02F 2103/001

(57) ABSTRACT

The present invention relates to a method for preparing an adsorbent for phosphorus adsorption and an adsorbent prepared by the method. Specifically, according to the present invention, the surface of conventional expanded vermiculite, which is effective for removal of cations but is not effective for removal of anions, is coated with sulfate to modify the surface, thereby preparing an adsorbent for phosphorus adsorption. Namely, the surface of expanded vermiculite is ionized by sulfate to thereby significantly increase the efficiency with which the anion phosphorus is removed by the expanded vermiculite. In addition, a floating-type adsorbent can be prepared using the expanded vermiculite as described above, and thus it can be quickly separated from water after adsorption without requiring a process for separating the absorbent from water.

### CROSS-REFERENCE TO RELATED APPLICATIONS

This application claims the benefit of Korean Patent Application No.10-2015-0166228, filed on Nov. 26, 2015 in the Korean Intellectual Property Office, which is incorporated herein by reference in its entirety.

### BACKGROUND OF THE INVENTION

### Field of the Invention

The present invention relates to a method for preparing an adsorbent for phosphorus adsorption, in which the surface of conventional expanded vermiculite, which is effective for removal of cations but is not effective for removal of anions, is coated with sulfate to modify the surface to thereby prepare an adsorbent for phosphorus adsorption, thus leading to a significant increase in the efficiency with which the anion phosphorus is removed by the expanded vermiculite, and to and an adsorbent prepared by the method.

### BACKGROUND ART

In general, when excessive phosphorus is introduced into rivers or lakes from the surroundings, eutrophication is likely to occur, which leads to the promotion of growth of algae. The propagation of algae due to eutrophication decreases the transparency of the water and blocks the penetration of sunlight into the water, so that the amount of dissolved oxygen is reduced and taste-and-odor compounds are produced, thus causing environmental problems such as the deterioration of the water quality and the destruction of water ecology (Sin et al., 2011).

Therefore, a variety of physical, chemical and biological removal technologies have been developed in order to remove phosphorus. Besides a biological treatment technique using microorganisms, a method for removing phosphorus chemically and physically includes ion exchange, precipitation, micro filtration, ultrafiltration, reverse osmosis, and the like. However, such a method entails a drawback in that the phosphorus is not completely removed, much reagent, energy and cost are required, and toxic sludge or another byproduct is produced (Lee & Yim. 2011; Yaghi & Hartikainen, 2013).

In recent years, researches are in progress on various types of phosphorus removal processes including a phosphorus removal process using industrial byproducts or natural minerals produced at low cost in various processes, and patent documents 1 to 5 are proposed as related prior arts.

Specifically, patent document 1 discloses a filter material for water purification, which is made of zeolite and functions to inhibit the occurrence of various foreign materials and adsorb the foreign materials.

Patent document 2 discloses a loess composition for water purification, which is based on loess and is disposed mainly in rivers and waterways for the purpose of naturally purifying running water.

In addition, patent document 3 discloses a porous sintered aggregate for water purification, which is prepared by sintering loess so as to be able to be used as a filter material for water purification and may further contain charcoal so as to be used as a filter material for plant growth and development.

Further, patent document 4 discloses a water treatment agent based on natural minerals and plants, which is prepared by powdering minerals such as silicate, elvan, loess, kaolin and zeolite, dissolving the powdery materials in hot water to make a colloidal water solution containing natural mineral components, and mixing the colloidal water solution with a water solution containing a natural sterilizer at a ratio of 1:1.

Particularly, as a related art of basically blocking or reducing the development of green algae by adsorbing and removing phosphorus among materials that cause the propagation of green algae in water, patent document 5 discloses a technology of forming charcoal powder consisting of, particularly, chaff, into charcoal balls capable of adsorbing phosphorus through a certain process.

However, the above-described prior art technologies have a problem in that the efficiency of adsorption of phosphorus is very low. Thus, in recent years, there has been an attempt to coat expanded vermiculite with iron in order to use the expanded vermiculite as an adsorbent for adsorbing phosphorus. However, in this case, the efficiency of adsorption of phosphorus also does not reach a satisfactory level.

### PRIOR ART LITERATURE

### Patent Documents

Patent Document 1: Korean Patent Laid-Open Publication No. 10-2005-0080053 entitled “Apparatus for Purifying Water”

Patent Document 2: Korean Patent Registration No. 10-0632249 entitled “Loess Composition for Water Purification and Block for Water Purification using the Same”

Patent Document 3: Korean Patent Registration No. 10-0567422 entitled “Method of Producing Porous Sintered Aggregate for Water Purification”

Patent Document 4: Korean Patent Registration No. 10-0623993 entitled “Method of Preparing Water Treatment Agent for Removing Green Algae and Moss”

Patent Document 5: Korean Patent Laid-Open Publication No. 10-2007-0026762 entitled “Water Purifying Charcoal Balls for Adsorbing Phosphorus In Water and Method of Producing The Same”

### SUMMARY OF THE INVENTION

The present invention has been made to solve the above-mentioned problems, and it is an object of the present invention to allow the surface of conventional expanded vermiculite, which is effective for removal of cations but is not effective for removal of anions, to be coated with sulfate, i.e., ionized by sulfate to modify the surface to thereby prepare an adsorbent for phosphorus adsorption, thus leading to a significant increase in the efficiency with which the anion phosphorus is removed by the expanded vermiculite.

Further, another object of the present invention is to allow a floating-type adsorbent to be prepared using the expanded vermiculite as described above, and thus to be quickly separated from water after adsorption without requiring a process for separating the absorbent from water.

To achieve the above objects, the present invention provides a method for preparing an adsorbent for phosphorus adsorption, the method comprising soaking expanded vermiculite with a sulfate solution, followed by heat treatment, and an adsorbent prepared by the method wherein the adsorbent comprises sulfate coated on the outer surface of expanded vermiculite.

Specifically, preferably, the method for preparing an adsorbent for phosphorus adsorption may include the steps of: (S100) mixing the sulfate solution with the expanded vermiculite; (S200) heat-treating the expanded vermiculite absorbed and coated with the sulfate solution in step S100; and (S300) cooling the expanded vermiculite heat-treated in step S200, followed by washing and drying.

Meanwhile, preferably, step S100 may include mixing the sulfate solution with the expanded vermiculite at a ratio of 3:1 to 5:1.

In this case, preferably, the sulfate solution may be obtained by mixing 3-5 parts by weight of sulfate with 100 parts by weight of water.

In addition, preferably, step S200 may include heat-treating the expanded vermiculite, absorbed and coated with the sulfate solution in step S100, by heating the expanded vermiculite to a temperature of 380 to 780° C. in an electric furnace.

Besides, preferably, step S300 may include: cooling the expanded vermiculite, heat-treated in step S200, to a temperature of 15 to 25° C.; washing the cooled expanded vermiculite with distilled water to a pH of 7-8; and drying the washed expanded vermiculite at a temperature of 75 to 85° C. for 20-25 hours.

According to the present invention, the surface of conventional expanded vermiculite, which is effective for removal of cations but is not effective for removal of anions, is coated with sulfate to modify the surface, thereby preparing an adsorbent for phosphorus adsorption. Namely, the surface of expanded vermiculite is ionized by sulfate to thereby significantly increase the efficiency with which the anion phosphorus is removed by the expanded vermiculite. Based on this, a floating-type adsorbent can be prepared using the expanded vermiculite as described above, and thus it can be quickly separated from water after adsorption without requiring a process for separating the absorbent from water.

### BRIEF DESCRIPTION OF THE DRAWINGS

The above and other objects, features and advantages of the present invention will be apparent from the following detailed description of the preferred embodiments of the invention when taken in conjunction with the accompanying drawings, in which:

FIG. 1 is a flowchart showing a method for preparing an adsorbent for phosphorus adsorption according to the present invention; and

FIG. 2 is a set of graphs showing the phosphorus adsorption patterns of the examples and comparative examples of the present invention and comparative examples.

### EXPLANATION ON SYMBOLS

S100: step of mixing sulfate solution with expanded vermiculite

S200: step of heat-treating the expanded vermiculite absorbed and coated with the sulfate solution in step S100

S300: step of cooling the expanded vermiculite heat-treated in step S200, followed by washing and drying

### DETAILED DESCRIPTION OF THE PREFERRED EMBODIMENTS

The present invention for achieving the above-mentioned effects is directed to a method for preparing an adsorbent for phosphorus adsorption and an adsorbent prepared by the same. It is to be noted that only portions necessary for understanding the technical constitution of the present invention will be described and the description of the remaining portions will be omitted to avoid obscuring the subject matter of the present invention.

Hereinafter, the method for preparing the adsorbent for phosphorus adsorption according to the present invention will be described in detail.

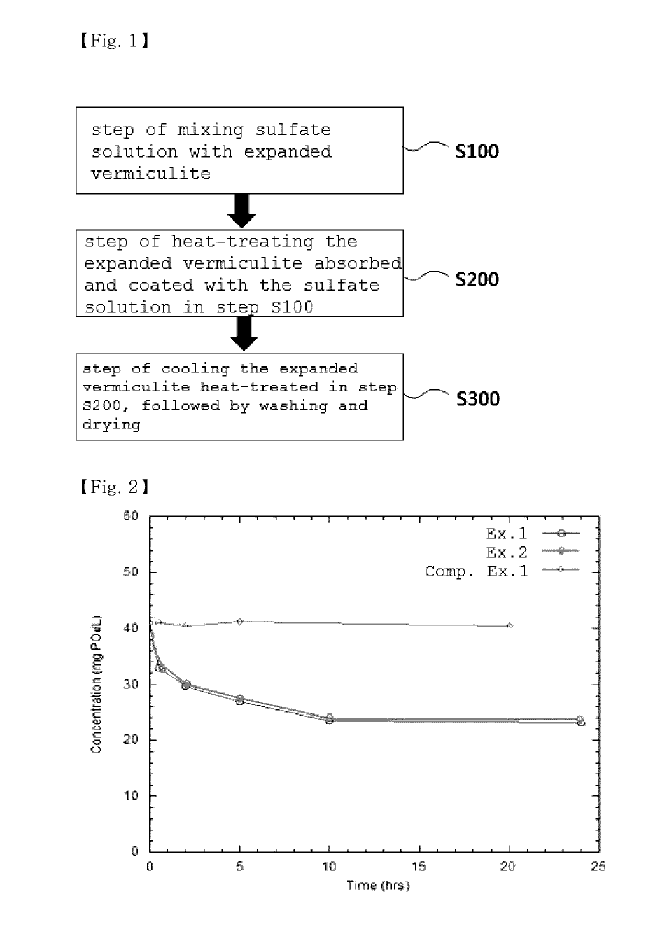

The method of the present invention is characterized in that it includes soaking expanded vermiculite with a sulfate solution, followed by heat treatment. Specifically, as shown in FIG. 1, the method of the present invention includes the steps of: (S100) mixing the sulfate solution with the expanded vermiculite; (S200) heat-treating the expanded vermiculite absorbed and coated with the sulfate solution in step S100; and (S300) cooling the expanded vermiculite heat-treated in step S200, followed by washing and drying.

Step S100 is a step of mixing the sulfate solution with the expanded vermiculite (its size is increased by about 15-fold compared to quarry stone). In step S100, the sulfate solution and the expanded vermiculite are mixed with each other at a ratio of 3:1 to 5:1. In this case, the sulfate solution that is used in the present invention is obtained by mixing 3-5 parts by weight of sulfate with 100 parts by weight of water.

In this case, if the mixture ratio of the sulfate solution to the expanded vermiculite is beyond the above-specified range, the sulfate solution may not be well absorbed and coated on the surface of the expanded vermiculite. If the content of the sulfate in the sulfate solution is beyond the above-specified range, the surface of the expanded vermiculite may not be modified during the heat treatment process which will be described later.

Step S200 is a step of heat-treating the expanded vermiculite, absorbed and coated with the sulfate solution in step S100, and includes heat-treating the expanded vermiculite, absorbed and coated with the sulfate solution in step S100, by heating the expanded vermiculite to a temperature of 380 to 780° C. in an electric furnace.

In this case, if the temperature of the heat treatment is beyond the above-specified range, the surface of the expanded vermiculite may not be ionized well.

Step S300 is a step of cooling the expanded vermiculite heat-treated in step S200, followed by washing and drying. When the specified temperature in step S200 is reached, the heating of the expanded vermiculite is terminated. Thereafter, the expanded vermiculite is cooled to room temperature (15 to 25° C.), and then the cooled expanded vermiculite is washed several times with distilled water to a pH of 7-8 and the washed expanded vermiculite is dried at a temperature of 75 to 85° C. for 20-25 hours.

In this case, if the cooling, washing and drying conditions are beyond the above-specified ranges, a charred layer on the surface of the expanded vermiculite may be likely to vanish.

As used herein, the term “expanded vermiculite” refers to vermiculite obtained by expanding conventional vermiculite by heat. The vermiculite has a layered structure with high cation exchange capability and specific surface area. On the other hand, when the expanded vermiculite is heated to a high temperature for a short period of time, thermal expoliation occurs generally in the vertical direction due to the explosive emission of interlayer water molecules. For this reason, the size of the expanded vermiculite is increased by about 20- to 30-fold compared to quarrel vermiculite so that the expanded vermiculite has a porous structure and can float on the water. By virtue of such0 characteristics, the expanded vermiculite can be used as a filter material or an inexpensive natural adsorbent for the road rainfall runoff. It is known that heavy metals are adsorbed through the cation exchange capability by the interaction between metal ions and permanent negative charges on the surface of vermiculite and the formation of an inner-sphere complex by Si—O and Al—O groups on the clay particle surface (Marcos & Rodriguez, 2014; Araujo Medeiros et al., 2009; Lee et al., 2009).

Hereinafter, the present invention will be described in further detail with reference to examples, but the scope of the present invention is not limited by these examples.

1. Preparation of Adsorbent for Phosphorus Adsorption

### Example 1

parts by weight of sulfate was mixed with 100 parts by weight of water to obtain a sulfate solution. The sulfate solution and 24 g of expanded vermiculite (its size is increased by about 15-fold compared to quarry stone) were mixed with each other at a ratio of 3:1 in a 500 mL beaker, and then the expanded vermiculite was heat-treated by being heated to a temperature of 380° C. in an electric furnace (CT-DMF 1, CORETECH, Korea). When a specified temperature was reached, the heating of the expanded vermiculite was terminated. Thereafter, the expanded vermiculite was cooled to room temperature, and then the cooled expanded vermiculite was washed several times with distilled water to reach a pH of 7-8 and the washed expanded vermiculite was dried at a temperature of 75° C. for 25 hours, thereby preparing an adsorbent for phosphorus adsorption.

### Example 2

parts by weight of sulfate was mixed with 100 parts by weight of water to obtain a sulfate solution. The sulfate solution and 24 g of expanded vermiculite (its size is increased by about 15-fold compared to quarry stone) were mixed with each other at a ratio of 4:1 in a 500 mL beaker, and then the expanded vermiculite was heat-treated by being heated to a temperature of 580° C. in an electric furnace (CT-DMF 1, CORETECH, Korea). When a specified temperature was reached, the heating of the expanded vermiculite was terminated. Thereafter, the expanded vermiculite was cooled to room temperature, and then the cooled expanded vermiculite was washed several times with distilled water to reach a pH of 7-8 and the washed expanded vermiculite was dried at a temperature of 80° C. for 24 hours, thereby preparing an adsorbent for phosphorus adsorption.

### Example 3

5 parts by weight of sulfate was mixed with 100 parts by weight of water to obtain a sulfate solution. The sulfate solution and 24 g of expanded vermiculite (its size is increased by about 15-fold compared to quarry stone) were mixed with each other at a ratio of 5:1 in a 500 mL beaker, and then the expanded vermiculite was heat-treated by being heated to a temperature of 780° C. in an electric furnace (CT-DMF 1, CORETECH, Korea). When a specified temperature was reached, the heating of the expanded vermiculite was terminated. Thereafter, the expanded vermiculite was cooled to room temperature, and then the cooled expanded vermiculite was washed several times with distilled water to reach a pH of 7-8 and the washed expanded vermiculite was dried at a temperature of 85° C. for 20 hours, thereby preparing an adsorbent for phosphorus adsorption.

### Comparative Example 1

Uncoated expanded vermiculite was used without any treatment.

2. Experimental Method

A. Phosphorus Adsorption Patterns of the Adsorbents of Examples and Comparative Example

2 g of each of the adsorbents prepared in Examples 1 and 2 and Comparative Example 1 was fixed to an about a 50-mL Teflon container, and 40 mL of a standard solution containing 40 mg/L of phosphate (KH₂PO₄) was added thereto and then stirred for 24 hours while a specific amount of a sample was collected at predetermined time points. The collected sample was filtered through a 0.45 μm filter, and then the concentration of phosphorus therein was measured. The results of the measurement are shown in FIG. 2.

As can be seen in FIG. 2, the expanded vermiculite of Comparative Example 1 adsorbed little or no phosphorus for hours, and the concentrations of phosphorus measured after 24 hours were 23.2 and 23.3 mg/L in Examples 1 and 2, respectively, suggesting that the adsorbents of Examples 1 and 2 more easily adsorbed phosphorus compared to the adsorbent of Comparative Example 1 and adsorbed almost all phosphorus within 10 hours.

As described above, according to the present invention, the surface of conventional expanded vermiculite, which is effective for removal of cations but is not effective for removal of anions, is coated with sulfate to modify the surface, thereby preparing an adsorbent for phosphorus adsorption. Namely, the surface of expanded vermiculite is ionized by sulfate to thereby significantly increase the efficiency with which the anion phosphorus is removed by the expanded vermiculite. In addition, a floating-type adsorbent can be prepared using the expanded vermiculite as described above, and thus it can be quickly separated from water after adsorption without requiring a process for separating the absorbent from water.

While the preferred embodiments of a method for preparing an adsorbent for phosphorus adsorption and an adsorbent prepared by the same according to the present invention has been shown and described with reference to the accompanying drawings and excellence of the adsorbent of the present invention has been confirmed, they are merely illustrative embodiments, and the invention is not limited to these embodiments. It is to be understood by a person having an ordinary skill in the art that various equivalent modifications and variations of the embodiments can be made without departing from the spirit and scope of the present invention. Therefore, various embodiments of the present invention are merely for reference in defining the scope of the invention, and the true technical scope of the present invention should be defined by the technical spirit of the appended claims.

1. A method for preparing an adsorbent for phosphorus adsorption, the method comprising soaking expanded vermiculite with a sulfate solution, followed by heat treatment.

2. The method of claim 1, comprising the steps of:
(S100) mixing the sulfate solution with the expanded vermiculite;
(S200) heat-treating the expanded vermiculite absorbed and coated with the sulfate solution in step S100; and
(S300) cooling the expanded vermiculite heat-treated in step S200, followed by washing and drying.

3. The method of claim 2, wherein step S100 comprises mixing the sulfate solution with the expanded vermiculite at a ratio of 3:1 to 5:1.

4. The method of claim 3, wherein the sulfate solution is obtained by mixing 3-5 parts by weight of sulfate with 100 parts by weight of water.

5. The method of claim 2, wherein step S200 comprises heat-treating the expanded vermiculite, absorbed and coated with the sulfate solution in step S100, by heating the expanded vermiculite to a temperature of 380 to 780° C. in an electric furnace.

6. The method of claim 2, wherein step S300 comprises:
cooling the expanded vermiculite, heat-treated in step S200, to a temperature of 15 to 25° C.;
washing the cooled expanded vermiculite with distilled water to a pH of 7-8; and
drying the washed expanded vermiculite at a temperature of 75 to 85° C. for 20-25 hours.

7. An adsorbent prepared by the method of claim 1, the adsorbent comprising sulfate coated on the outer surface of expanded vermiculite.

8. An adsorbent prepared by the method of claim 2, the adsorbent comprising sulfate coated on the outer surface of expanded vermiculite.

9. An adsorbent prepared by the method of claim 3, the adsorbent comprising sulfate coated on the outer surface of expanded vermiculite.

10. An adsorbent prepared by the method of claim 4, the adsorbent comprising sulfate coated on the outer surface of expanded vermiculite.

11. An adsorbent prepared by the method of claim 5, the adsorbent comprising sulfate coated on the outer surface of expanded vermiculite.

12. An adsorbent prepared by the method of claim 6, the adsorbent comprising sulfate coated on the outer surface of expanded vermiculite.
